(19) United States
(12) Patent Application Publication
(10) Pub. No.: US 2025/0021511 A1
(43) Pub. Date: Jan. 16, 2025

(54) Programmable Interface Circuit to Operate Sensors

(71) Applicant: Texas Instruments Incorporated, Dallas, TX (US)

(72) Inventor: Saya Goud Langadi, Sugar Land, TX (US)

(21) Appl. No.: 18/220,353

(22) Filed: Jul. 11, 2023

(51) Int. Cl. G06F 13/42

(52) U.S. Cl. CPC G06F 13/4282; G06F 2213/0002

(57) ABSTRACT

A microcontroller may include a programmable interface circuit to operate one or more sensors. The interface circuit may include a first set of storage to store a first set of values. The first set of values may specify a period and a set of transitions for a first signal. The interface circuit may include one or more second sets of storage to store one or more second sets of values respectively. The second sets of values may each specify a period and a set of transitions for a respective one of one or more second signals. The interface circuit may include a signal generator operatively coupled to the first and second sets of storage to generate the first and second signals based on the first and second sets of values.

### BACKGROUND

A wide range of microcontroller applications involve communication between the microcontroller and one or more sensors. However, to keep costs low, many of these sensors may include minimal control and communications capability. For example, Single Edge Nibble Transmission (SENT) protocol is a simple serial communication protocol commonly used in low-cost sensors for transmitting signal values from a SENT sensor to a data receiving device. SENT sensors, for example, can be used in automotive applications to measure steering angle and torque, throttle position, temperature, and mass airflow, in industrial applications for process monitoring and fluid pressure measurement, and in consumer appliances for filter monitoring. The traditional SENT protocol, e.g., as specified in the SAE J2716 standard, is a unidirectional serial protocol where data from a SENT sensor is transmitted independently without any intervention of the receiving device. A SENT message includes a series of pulses of variable widths in which values are encoded into the times between two falling edges. The receiving device can decode the signal values by measuring the widths. Recent technology advancement brings new features to SENT sensors. Accordingly, SENT sensors in the market can require different ways of communication in addition to the standard SENT protocol. Therefore, it is desired to have a generic interface circuit that is able to operate SENT sensors having different communication requirements.

### SUMMARY

SENT is merely one of the many sensor communication and control protocols, and this disclosure describes a programmable interface circuit to operate sensors which may have a wide range of different communication requirements. In some examples, the programmable interface circuit may include a first set of storage, one or more second sets of storage, and a signal generator. The first set of storage may store a first set of values associated with communication with one or more sensors, such as SENT sensors, and the first set of values may specify a period and a set of transitions for a first signal. The one or more second sets of storage may each store a second set of values associated with communication with a corresponding one of the one or more sensors, and the second set of values may specify a period and a set of transitions for a respective second signal. The signal generator may be coupled to the first set of storage and the one or more second sets of storage and may generate the first signal based on the first set of values and one or more second signals based on the respective one or more second sets of values.

In some examples, a system such as a microcontroller, a digital signal processor (DSP), and/or other types of control devices may include a trigger generation circuit and a programmable interface circuit. The trigger generation circuit may generate a first trigger and one or more second triggers. The programmable interface circuit may include a first set of storage, one or more second sets of storage, and a signal generator. The first set of storage may store a first set of values associated with communication with one or more sensors, such as SENT sensors, and the first set of values may specify a period and a set of transitions for a first signal. The one or more second sets of storage may each store a second set of values associated with communication with a corresponding one of the one or more sensors, and the second set of values may specify a period and a set of transitions for a respective second signal. The first set of storage and the one or more second sets of storage may receive the first trigger and the respective one or more second triggers generated by the trigger generation circuit to cause the signal generator to generate the first signal based on the first set of values and one or more second signals based on the respective one or more second sets of value.

In some examples, a non-transitory computer readable medium may store program instructions. The non-transitory computer readable medium may be part of a control device such as a microcontroller, a DSP, and/or other types of control devices. The program instructions may be executed by a processing unit to cause the processing unit to store at a first set of storage a first set of values associated with communication with one or more sensors, such as SENT sensors, wherein the first set of values may specify a period and a set of transitions for a first signal. The program instructions may further cause the processing unit to store at one or more second sets of storage one or more second sets of values respectively associated with communication with respective ones of the one or more sensors, wherein the one or more second sets of values may each specify a period and a set of transitions for a respective second signal. The program instructions may further cause the processing unit to generate at a signal generator the first signal based on the first set of values and one or more second signals based on the respective one or more second sets of values.

These and other features will be better understood from the following detailed description with reference to the accompanying drawings.

### BRIEF DESCRIPTION OF THE DRAWINGS

FIG. 1 is a block diagram of an interface circuit operating one or more sensors according to some examples;

FIG. 2 is a graphic representation of signals that may be generated at an interface circuit according to some examples;

FIG. 3 is a graphic representation of signals that may be generated to operate one or more sensors according to some examples;

FIG. 4 is a block diagram of an interface circuit operating one or more sensors according to some examples;

FIG. 5 is a block diagram of an interface circuit operating one or more sensors according to some examples;

FIG. 6 is a graphic representation of communication between an interface circuit and one or more sensors according to some examples;

FIG. 7 is a block diagram of an interface circuit operating one or more sensors according to some examples;

FIG. 8 is a block diagram of an interface circuit operating one or more sensors according to some examples;

FIG. 9 is a flowchart of a method for using an interface circuit to operate one or more sensors according to some examples;

FIG. 10 is a flowchart of a method for using an interface circuit to operate one or more sensors according to some examples; and

FIG. 11 is a schematic block diagram illustrating an exemplary system of hardware components configurable to implement examples of systems and methods describes above.

The same reference numbers or other reference designators are used in the drawings to designate the same or similar (functionally and/or functionally) features. Specific examples are described below in detail with reference to the accompanying figures. These examples are not intended to be limiting. In the drawings, corresponding numerals and symbols generally refer to corresponding parts unless otherwise indicated. The objects depicted in the drawings are not necessarily drawn to scale.

### DETAILED DESCRIPTION

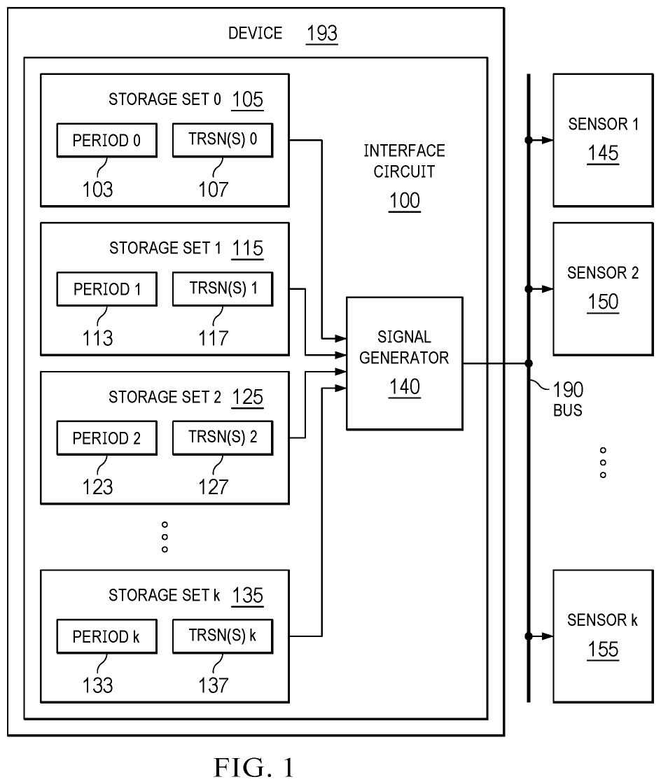

FIG. 1 is a block diagram of an interface circuit operating one or more sensors according to some examples. In FIG. 1, an interface circuit 100 may be part of a device 193 for the device 193 to operate one or more sensors 145, 150, and 155. In some examples, the device 193 may include a microcontroller, a processor, a digital signal processor (DSP), and/or other types of control devices. In some examples, the sensors 145, 150, and 155 may be operatively coupled to a common bus line 190, through which the interface circuit 100 may communicate with the sensors. For example, the device 193 may function as a host, whereas the interface circuit 100 may serve as an “interface” of the host for communication with and operation of the sensors 145, 150, and 155. In some examples, the sensors 145, 150, and 155 may be able to operate according to various communication protocols, including the traditional and/or specialized SENT protocols with customized features. For example, at least some of the sensors 145, 150, and 155 may operate in a unidirectional mode in which the sensors may send signals to a data receiving device, e.g., the interface circuit 100, without intervention of the receiving device. Alternatively, at least some of the sensors 145, 150, and 155 may operate in a bidirectional mode. The sensors may receive signals (e.g., a trigger signal) from a data receiving device, e.g., the interface circuit 100, and in response return signals back to the data receiving device. In some examples, at least some of the sensors 145, 150, and 155 may support synchronous signal transmission. For example, a data receiving device, e.g., the interface circuit 100, may send trigger signals, e.g., one or more low or high pulses, to the sensors. Upon receipt of the trigger signals, the sensors may respond to return the signals. In some examples, the trigger signals may be sent in a fixed sequence, e.g., to the sensor 145 first, the sensor 150 next, and so on until the sensor 155. In response, the sensor 145 may return signal first, the sensor 150 150 may return signals second, and so on. In some examples, the trigger signals may include address information such that specific sensors may be selected to return signals. For example, the interface circuit 100 may send a trigger signal addressed to the sensor 150 first, a trigger signal addressed to sensor 145 next, and so on. Additionally, the sensors may not necessarily be selected according to a fixed sequence. Instead, a user may flexibly configure addresses of the trigger signals, as needed, to selectively request particular sensors to return measurement values. In summary, depending on design of the sensors, the sensors 145, 150, and 155 may require different communication protocols, and the interface circuit 100 may be configured to support the various communication protocols. In addition, different communication protocol may specify the encoding in different ways. In some examples, the address information may be encoded in the trigger signals using the widths of pulses. Moreover, the widths of the pulses may vary from one protocol to another. Further, some may encode various information using the timing of a rising edge, whereas others may encode the information in the timing of a falling edge.

In some examples, the interface circuit 100 may include a first set of storage 105, one or more second sets of storage 115, 125, and 135, and a signal generator 140. Each of the sets of storage 105, 115, 125, and 135 (hereinafter “storage sets”) may include one or more storage, e.g., registers, memory storages, and/or other types of storage components, to store a set of values for at least a first parameter and one or more second parameters associated with communication with the sensors 145, 150, and 155. For example, the storage set 105 may store a value of a period parameter 103 and values of one or more transition parameters 107 for a handshaking instruction to be broadcast to all of the sensors 145, 150, and 155. The storage set 115 may store values of a period parameter 113 and one or more transition parameters 117 for a trigger instruction that causes only sensor 145 to respond with a measurement value, the storage set 125 may store values of a period parameter 123 and one or more transition parameters 127 for a trigger instruction that causes only sensor 150 to respond with a measurement value, and the storage set 135 may store values of a period parameter 133 and one or more transition parameters 137 for a trigger instruction that causes only sensor 155 to respond with a measurement value. In some embodiments, the storage sets 105, 115, 125, and 135 may obtain the values from one or more non-transitory computer readable media. In some examples, the signal generator 140 may be coupled to the storage sets 105, 115, 125, and 135, and may obtain the stored values and accordingly generate the handshaking signal and trigger signals for the respective storage sets. In some examples, the storage sets 105, 115, 125, and 135 may be implemented using any appropriate data storage circuit(s), e.g., flash memory, ROM memory, and/or RAM memory. In some examples, the signal generator 140 may be implemented using any appropriate signal synthesis circuit(s).

In some examples, a value of a period parameter may specify a period of a signal, whereas values of transition parameters may specify transitions of the signal. For example, a value of the period 103 may be an integer or floating point number. It may indicate the period of a first signal to be generated for the storage set 105. Similarly, the transition parameters 107 may include an array of one or more integer or floating point numbers. In some examples, the values of the transition parameters 107 may compare with a value generated from a counter (e.g., an up counter, a down counter, an up-down counter, etc.). Equivalence between the two values may indicate a rising or falling transition of the signal. Therefore, with the period parameter 103 and transition parameters 107, the period and shape of one or more pulses of the first signal may be determined.

In some examples, values of the period parameter and/or transition parameters for each of the storage sets 105, 115, 125, and 135 may be programmable. For example, a user may set one or more of the parameters to specific values using program instructions. Thus, given communication requirements of the sensors 145, 150, and 155, a user may customize the signals to be generated from the signal generator 140 by configuring values of their period and transition parameters at the storage sets 105, 115, 125, and 135 to operate the sensors. In other words, the storage sets 105, 115, 125, and 135 may be considered as programmable “channels,” and the signal generator 140 may generate signals according to the channels' respective configurations.

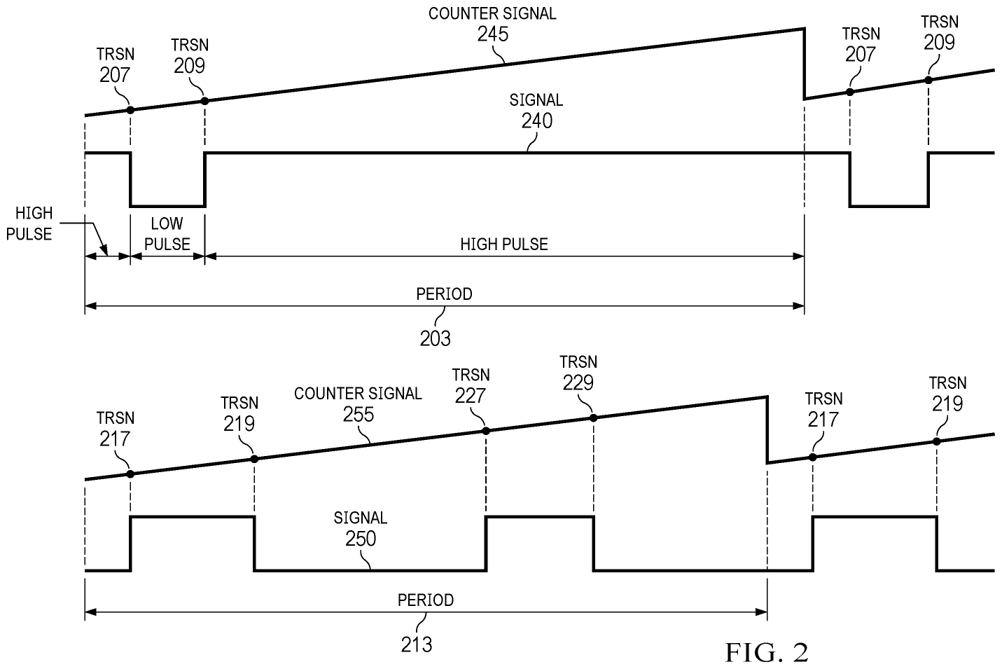

FIG. 2 is a graphic representation of signals that may be generated at a programmable interface circuit according to some examples. In FIG. 2, a signal 240 may be generated at a signal generator of a programmable interface circuit, e.g., the signal generator 140 of FIG. 1, according to values of a period parameter 203 and transition parameters 207 and 209. In some examples, these values may be stored at a set of storage, e.g., one of the storage sets 105, 115, 125, and 135.

As shown in FIG. 2, the signal 240 may be a signal including one or more high or low pulses. In some examples, the period of signal 240 may be specified by a value of the period parameter 203. Throughout the period, there may be a finite number of points in time where the signal 240 may transition. In some examples, the transition parameters 207 and 209 may each have a value for each possible transition point that indicates whether the signal 240 transitions at that point in time. Thus, transitions and thus the one or more pulses of the signal 240 may be specified by values of the transition parameters 207 and 209. For example, the values of transition parameters 207 and 209 may each compare with a value 245 generated by an up counter. The value 245 may linearly increase from a start value, e.g., zero, to a stop value. When the value 245 equals values of the transition parameters 207 and 209, a corresponding transition may be generated by the signal generator for signal 240. For example, in FIG. 2, when the value 245 equals the value of transition parameter 207, the signal 240 may transition from a logic high voltage to a logic low voltage to thus generate a falling edge. When the value 245 continues to increase to the value of transition parameter 209, the signal 240 may toggle from the logic low voltage to the logic high voltage to generate a rising edge. As a result, the signal 240 may include two high pulses and one low pulse in-between within each period 203. In summary, the positions and widths of these pulses may be determined by values of the period parameter, the transition parameters, and the counter output. In some examples, the signal 240 may last only one single period. Alternatively, in some examples, the signal 240 may repeat for multiple periods, as shown in FIG. 2.

In some examples, the number of transitions, the direction of transitions, etc. may be programmable to generate signals of particular shapes. For example, in FIG. 2, a signal generator, e.g., the signal generator 140 of FIG. 1, may generate another signal 250 according to values of a period parameter 213 and transition parameters 217, 219, 227, and 229. Similar to the signal 240, the period of signal 250 may be specified by a value of the period parameter 213, whereas transitions of the signal 250 may be specified by values of the transition parameters 217, 219, 227, and 229. For example, values of the transition parameters 217, 219, 227, and 229 may each compare with a value 255 from an up counter to generate the high and low pulses of the signal 250. However, different from the signal 240, the signal 250 may include more pulses using more transition parameters. In addition, for purposes of illustration, transition directions of the pulses in the signal 250 may be configured to be different from the signal 240. For example, the first pulse of the signal 250 is a high pulse instead of a low pulse. Moreover, the signal 250 may be configured to have a shorter period less than the signal 240. Note that FIG. 2 is provided only as a non-limiting example for purposes of illustration. Given a particular sensor, a user may configure values of the period and transition parameters, the number of transitions, the transition directions, the counter output values, etc. to generate customizable pulses to meet the sensor communication requirements.

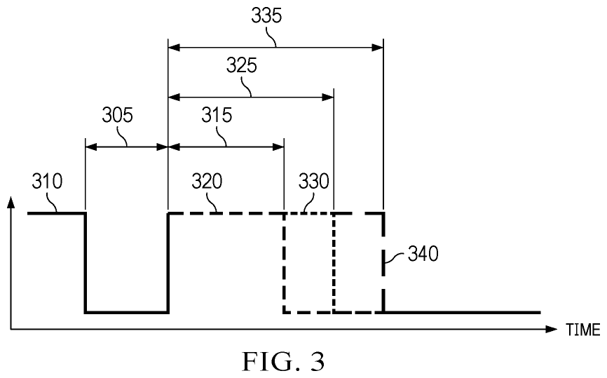

FIG. 3 is a graphic representation of signals that may be generated to operate one or more SENT sensors according to some examples. For purposes of illustration, the signals are stacked together to show their different characteristics. But note that they correspond to separate signals generated by the signal generator for different storage sets. In FIG. 3, the signal 310 may be a handshaking signal generated by an interface circuit, e.g., the interface circuit 100 of FIG. 1, to perform handshaking with (e.g., reset) one or more sensors. In some examples, the signal 310 may be broadcasted to all the sensors through a common bus line (e.g., bus 190). In some examples, the signal 310 may include one low (or high) pulse of a specified pulse width 305, e.g., j microseconds (μs). When the sensors receive the signal 310, they may recognize that this is a handshaking signal, for example, based on the pulse width 305 of the received low pulse. Alternatively, in some examples, the handshaking may be performed based on a specific sequence of pulses in the signal 310. In some examples, a handshaking signal may perform one or more handshaking actions. For example, it may wake up the sensors, reset the sensors, synchronize and/or calibrate tick times between the sensors and a data receiving device such as the interface circuit, etc. to make the sensors ready to communicate and send signals to the data receiving device (e.g., the interface circuit 100). In addition, in some embodiments, once the handshaking signal is broadcasted to all the sensors, the interface circuit may not necessarily expect any acknowledgement or return signals from the sensors in response. As described above, in some examples, the signal 310 may be generated at a signal generator (e.g., the signal generator 140 of FIG. 1) of the interface circuit based on values of period and transition parameters (e.g., the period parameter 103 and transition parameters 107) stored at a storage set (e.g., the storage set 105). Additionally, in some examples, the signal 310 may last only one single period. Alternatively, in some examples, it may last multiple periods.

In some examples, the interface circuit may further generate one or more signals 320, 330, and 340 based on values of period and transition parameters stored at one or more additional storage sets. For example, the interface circuit may use the signal generator to generate the signal 320 based on values of period parameter 113 and transition parameters 117 stored at the storage set 115, generate the signal 330 based on values of period parameter 123 and transition parameters 127 stored at the storage set 125, and generate the signal 340 based on values of period parameter 133 and transition parameters 137 stored at the storage set 135. Different from the signal 305, in some examples, the signals 320, 330, and 340 may be addressed to selective ones of the SENT sensors. For example, the signal 320 may be addressed to the sensor 145 of FIG. 1, the signal 330 may be addressed to the sensor 150, and the signal 340 may be addressed to the sensor 155. In some examples, the signals 320, 330, and 340 may each include one high (or low) pulse, as shown in FIG. 3, and addresses of the sensors 145, 150, and 155 may be encoded respectively into pulse widths 315, 325, and 335 of the high pulses of the signals. For example, the pulse width 315 may be k μs representing the address of the sensor 145, the pulse width of 325 may be m μs representing the address of the sensor 150, and the pulse width 335 may be n μs representing the address of the sensor 155. In some examples, the pulse width of a high pulse may be specified by the timing of the falling edge of the high pulse. For examples, as shown in FIG. 3, by adjusting the falling edges of the pulses further to the right, the widths of the pulses 320, 330, and 340 may be increased from 315 to 325 and 335.

When the sensors receive the signals 320, 330, and 340, they may determine which particular sensor each of the signals is addressed to based on the pulse widths 315, 325, and 335, or the timing of the falling edges, of the respective signals. As described above, in some examples, sensors such as SENT sensors may support synchronous signal transmissions in which the sensors may be selectively addressed to send signals (e.g., measurement values) to a data receiving device. Thus, in some examples, the signals 315, 325, and 335 may function as the trigger signals addressed to the sensors 145, 150, and 155 respectively. Upon receipt of the trigger signals, the sensors 145, 150, and 155 may respectively respond to send signals (e.g., measurement values) back to a data receiving device such as the interface circuit. Note that FIG. 3 is provided only as a non-limiting example for purposes of illustration. In some examples, the sensors may be reset and/or addressed with different signals. For example, the handshaking signal 310 may be a high pulse rather than a low pulse. Similarly, the trigger signals may be variable-width low pulses instead of high pulses.

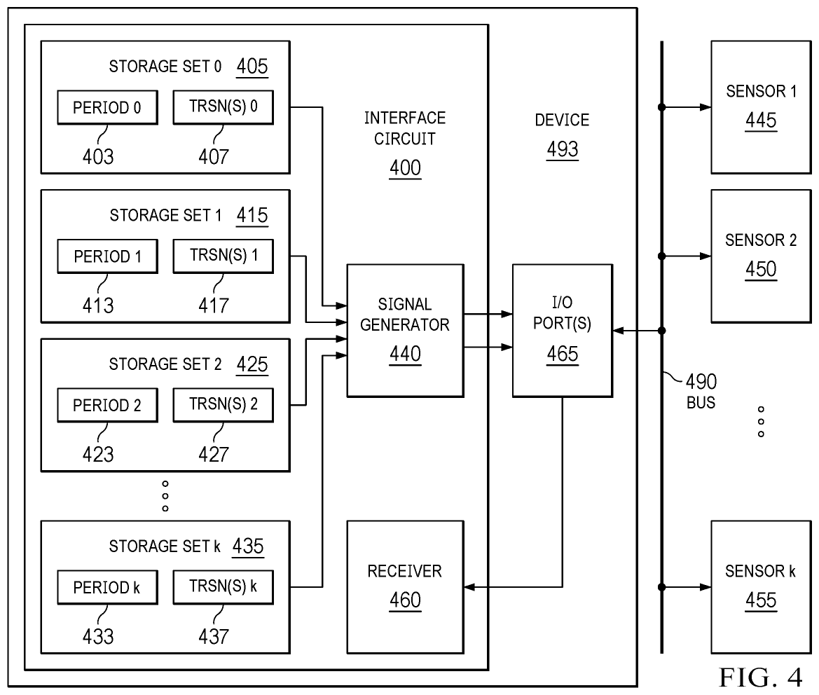

FIG. 4 is a block diagram of an interface circuit operating one or more sensors according to some examples. FIG. 4 shows an interface circuit 400 similar to the interface circuit 100 of FIG. 1. FIG. 4 differs from FIG. 1 in showing a SENT receiver as part of the interface circuit 400. In FIG. 4, the interface circuit 400 may be part of a device 493, such as a microcontroller, a DSP, and/or other types of control devices. The interface circuit 400 may include a first set of storage 405, one or more second sets of storage 415, 425, and 435, a signal generator 440, and a receiver 460. In some examples, the storage sets 405, 415, 425, and 435 may be similar to the storage sets 105, 115, 125, and 135 of FIG. 1. For example, the storage sets 405, 415, 425, and 435 may each include one or more registers storing a corresponding set of values for a first parameter and one or more second parameters associated with one or more sensors and/or one or more instructions. As shown in FIG. 4, the storage set 405 may store values of a period parameter 403 and one or more transition parameters 407, the storage set 415 may store values of a period parameter 413 and one or more transition parameters 417, the storage set 425 may store values of a period parameter 423 and one or more transition parameters 427, and the storage set 435 may store values of a period parameter 433 and one or more transition parameters 437.

In some examples, the signal generator 440 may be similar to the signal generator 140 of FIG. 1. The signal generator 440 may generate signals for the storage sets 405, 415, 425, and 435 respectively based on values of the period and transition parameters stored at the respective storage sets. In some examples, a value of a period parameter may specify a period of a signal, whereas values of the transition parameters may specify transitions of the signal. In addition, in some examples, values of the period parameter and transition parameters may be programmable, such that the signal generator 440 may generate customizable signals having particular periods and/or pulses to support SENT sensors having different communication requirements.

In FIG. 4, one or more sensors 445, 450, and 455 may be operatively coupled to a common bus line 490. In some examples, the sensors 445, 450, and 455 may include SENT sensors. The interface circuit 440 may also operatively couple to the bus 490 through one or more input/output (I/O) ports 465. Through I/O ports 465 and bus 490, the interface circuit 400 may communicate with the sensors 445, 450, and 455. For example, the sensors 445, 450, and 455 may receive signals (e.g., broadcast signal and/or trigger signals as described above) from the interface circuit 400, and in response send signals (e.g., including measurement values) to the interface circuit 400, all through the I/O port(s) 465.

In some examples, the signals from the sensors 445, 450, and 455 may be received at the receiver 460 of the interface circuit 400. In some examples, the receiver 460 may include a digital receiver to receive the signals and decoder to decode the signals. For example, the receiver 460 may be able to decode the received signals, e.g., based on widths of pulses, timing of edges, etc., incorporated in the signals, to determine encoded values (e.g., measurement values). Additionally, in some examples, the receiver 460 may include a memory storage to store the digital values. In some examples, the I/O port(s) 465 may operate in either output or input direction under control of the signal generator 440. For example, when the interface circuit 400 transmits signals to the sensors 445, 450, and 455, the interface circuit 400 may send a control signal to the I/O port(s) 465 to operate as output port(s). Alternatively, when the interface circuit 400 receives signals, e.g., after transmission of the signals, the interface circuit 400 may send a control signal to the I/O port(s) 465 to operate as input port(s). Additionally, in some examples, the receiver 460 may be decoupled from and thus blocked to “see” the bus 490 when the interface circuit 400 sends out signals to the sensors.

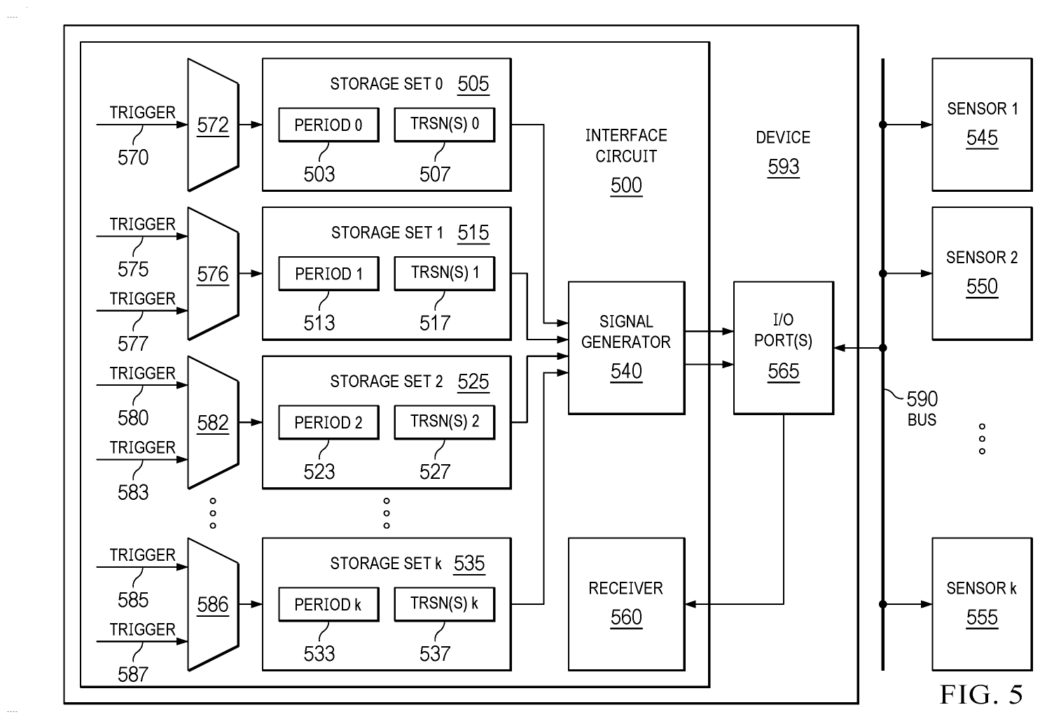

FIG. 5 is a block diagram of an interface circuit operating one or more SENT sensors according to some examples. FIG. 5 shows an interface circuit 500 similar to the interface circuit 400 of FIG. 4. FIG. 5 differs from FIG. 4 in showing triggers to storage sets of the interface circuit 500. In FIG. 5, the interface circuit 500 may be part of a device 593, such as a microcontroller, a DSP, and/or other types of control devices. The interface circuit 500 may include a first set of storage 505, one or more second sets of storage 515, 525, and 535, a signal generator 540, and a receiver 560. The storage sets 505, 515, 525, and 535 may be similar to the storage sets 405, 415, 425, and 435 of FIG. 4. For example, the storage sets 505, 515, 525, and 535 may each include one or more registers to store a corresponding set of values for a first parameter and one or more second parameters associated with one or more sensors and/or one or more instructions. As shown in FIG. 5, the storage set 505 may store values of a period parameter 503 and one or more transition parameters 507, the storage set 515 may store values of a period parameter 513 and one or more transition parameters 517, the storage set 525 may store values of a period parameter 523 and one or more transition parameters 527, and the storage set 535 may store values of a period parameter 533 and one or more transition parameters 537.

In some examples, the signal generator 540 may be similar to the signal generator 440 of FIG. 4. The signal generator 540 may generate signals for the storage sets 505, 515, 525, and 535 respectively according to values of the period and transition parameters stored at the storage sets. In some examples, a value of a period parameter may specify a period of a signal, whereas values of the transition parameters may specify transitions of the signal. In addition, values of these period parameter and/or transition parameters may be programmable, such that the signal generator 540 may generate customizable signals having particular periods and/or pulses to operate sensors, e.g., SENT sensors, having different communication requirements. In some examples, the receiver 560 may be similar to the receiver 460 of FIG. 4, and I/O port(s) 565 may be similar to the I/O ports 465 of FIG. 4. For example, the I/O port(s) 565 may operate in either output or input direction under control of the signal generator 540. Similarly, upon receiving signals from the sensors, the receiver 560 may decode the signals and store signal values in a memory storage.

In some examples, the storage sets 505, 515, 525, and 535 may receive triggers, as shown in FIG. 5. The triggers may cause the storage sets to request the signal generator 540 to generate corresponding signals. For examples, the storage set 505 may receive trigger 570. When the trigger 570 includes a high or low pulse, the storage set 505 may be triggered to request signal generator 540 (e.g., by sending the stored values to the signal generator 540) to generate and transmit a signal to the sensors 545, 550, and 555. Alternatively, when the trigger 570 is a constant value without the pulse, the signal generator 540 may not be requested to generate the signal.

In some examples, a storage set may receive more than one trigger. In that case, the storage set may be triggered based on at least one of the triggers. As shown in FIG. 5, for example, the storage set 515 may receive two triggers 575 and 577. In some examples, the storage set 515 may be triggered based on one or more logic operations of the triggers 575 and 577. For example, the interface circuit 500 may include a multiplexer 576 coupled operatively between the triggers 575 and 577 and the storage set 515. The multiplexer 576 may be configured, e.g., by a user, to select one of the triggers 575 and 577 to trigger the storage set 515. In some examples, the triggers may be selected based on the triggers' priorities, which may be assigned by a user. In another example, instead of multiplexing, the logic operations may include logic OR, logic AND, etc. to calculate a composite output from triggers 575 and 577 to trigger the storage set 515. Similarly, in FIG. 5, the storage set 525 may receive triggers 580 and 585, and storage set 535 may receive triggers 585 and 587, which may then be triggered respectively based on logic operations of their received triggers, e.g., using multiplexers 582 and 586. For purposes of illustration, FIG. 5 also shows a multiplexer 572 operatively coupled in front of the storage set 505.

In some examples, triggers to the storage sets 505, 515, 525, and 535 may be independent from one another. For example, the trigger 570, 575, 580, and 585 may be independently generated, e.g., from a pulse-width-modulation (PWM) control module of the device 593. Accordingly, the storage sets 505, 515, 525, and 535 may be triggered independently by those separate triggers to cause the signal generator 540 to generate the corresponding signals.

In some examples, triggers to the storage sets 505, 515, 525, and 535 may have one or more dependent relationship. For example, the trigger 577 to the storage set 515 may be associated with status of the signal generated (by the signal generator 540) for the storage set 505. For example, the trigger 577 may be able to trigger the storage set 515 only after a first signal (e.g., a broadcast handshaking signal) has been generated for the storage set 505 (as triggered by the trigger 570) to the sensors 545, 550, and 555. Thus, this may ensure that the signal generator 540 generates a second signal for the storage set 515 (e.g., a trigger signal addressed to one of the sensors) after the first signal for the storage set 505 (e.g., the first broadcast signal) has been transmitted. In other words, the first and second signals may be generated in sequence for the storage sets 505 and 515.

In some examples, the trigger 583 to storage set 525 may depend on receiving a signal (e.g., measurement values) from one of the sensors 545, 550, and 555 at the receiver 560 corresponding to the second signal generated for the storage set 515 (as triggered by triggers 575 and/or 577). This may ensure that the signal generator 540 generates the third signal for the storage set 525 after the interface circuit 500 receives the signal (e.g., measurement values) from the (addressed) sensor corresponding to the second signal generated for the storage set 515. Similarly, the trigger 587 to storage set 535 may depend on receiving a signal (e.g., measurement values) from one of the sensors 545, 550, and 555 at the sensor 560 corresponding to a third signal generated for storage set 525 (as triggered by triggers 580 and/or 583). This may ensure that the signal generator 540 generates a fourth signal for the storage set 535 after the interface circuit 500 receives the signal (e.g., measurement values) from the addressed sensor in response to the third signal generated for the storage set 525.

In summary, the dependent relationships between the triggers may allow the triggers to form a “chain”, such that the interface circuit 500 may generate the signals according to a specified sequence. For example, in some examples, the interface circuit 500 may generate and transmit a first signal for the storage set 505. As described above, in some example, the first signal may be a broadcast signal to all the sensors to perform handshaking, and the interface circuit 500 may not necessarily expect feedback from the sensor. Next, the interface circuit 500 may generate and transmit a second signal for storage set 515, then wait for a response signal from the sensors, then generate and transmit a third signal for the storage set 525, and then wait to receive the next response signal in return from the sensors. The operations may continue until the signal generator 540 generates signals for all the storage sets and receives corresponding response signals from all the sensors. Therefore, with the dependent relationships, the interface circuit 500 may generate signals for the storage sets 505, 515, 525, and 535 in a particular sequence. In some embodiments, the dependent relationships may be programmable, such that the sequence of the generated signals may be customizable. As described above, in some examples, the sensors may have different communication requirements, e.g., the traditional and/or specialized SENT protocols. Therefore, by programming the relationships in combination with above described programmable handshaking and addressed trigger signals, the interface circuit 500 may be able to generate required signals according to various communication protocols to operate the sensors.

In some examples, some or all of the triggers 570-587 may be “software triggers”. For example, a user may directly write to control register(s) to set or reset the triggers. The control register(s) may be part of the storage sets 505, 515, 525, and 535, or may be register(s) external to the storage sets. In some examples, the storage sets 505, 515, 525, and 535 may store values for one or more additional parameters. For example, they may store enable/disable parameters which may activate/deactivate the storage sets respectively. Moreover, the storage sets 505, 515, 525, and 535 may have values for time-out parameters specifying time intervals. When the interface circuit 500 generates a signal, e.g., a trigger signal, but does not receive an expected return from the sensors 545, 550, 555 within the specified time interval, an error may be generated. In some examples, the time-out feature may be critical for certain applications especially from the safety perspective.

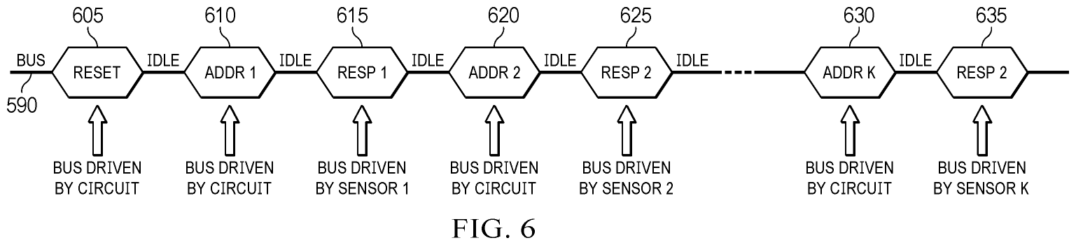

FIG. 6 is a graphic representation of communication signals between an interface circuit and one or more sensors according to some examples. FIG. 6 shows signals transmitted through the bus line 590 between the interface circuit 500 and one or more sensors 545, 550, and 555. In some examples, the interface circuit 500 may use the signal generator 540 to generate a signal 605 based on values of period parameter 503 and 507 stored at the storage set 505. In some examples, the signal 605 may be similar to the signal 310 of FIG. 3, which may include, e.g., one or more low or high pulses having specified pulse widths. As described above, the interface circuit 500 may broadcast the signal 605 through the bus 590 to all the sensors 545, 550, and 555 to perform handshaking with the sensors, e.g., to reset the sensors, synchronize and/or calibrate tick times, etc., such that the sensors may become ready to communicate and transmit response signals (e.g., measurement values) to the interface circuit 500. As described above, in some examples, the interface circuit 500 may not necessarily expect feedback from the sensors.

Next the interface circuit 500 may generate a signal 610 based on values of period parameter 513 and transition parameters 517 stored at the storage set 515. In some examples, the signal 610 may be similar to the signal 320 of FIG. 3, which may include a pulse of a particular width representing a trigger signal addressed specifically to the sensor 545. Therefore, the interface circuit 500 may transmit the signal 610 to selectively request the sensor 545 to respond and send a signal 615 (e.g., measurement values) to the interface circuit 500. As described above, in some examples, the storage sets 505 and 515 may receive triggers that may have dependent relationship, such that the interface circuit 500 may generate the signals 605 and 610 in a customized particular sequence, as shown in FIG. 6.

Next the interface circuit 500 may receive the signal 615 from the sensor 545. As described above, the signal 615 may be received at the receiver 560. In some examples, the receiver 560 may decode the signal and store the digital values at memory storages. In addition, as described above, in some examples, the storage set 515 may have a time-out parameter specifying a time duration. In that case, when the interface circuit 500 fails to receive the signal 615 within the time-out duration, the interface circuit 500 may generate an error.

Next the interface circuit 500 may generate a signal 620 based on values of period parameter 523 and transition parameters 527 stored at the storage set 525. In some examples, the signal 620 may be similar to the signal 330 of FIG. 3, which may include a pulse of a particular width representing a trigger signal addressed specifically to the sensor 555. Therefore, the interface circuit 500 may transmit the signal 620 to selectively request the sensor 555 to send back a signal 635 (e.g., measurement values). As described above, in some examples, the storage sets 515 and 525 may receive triggers that may have dependent relationships, such that the signals 610, 615, and 620 may be transmitted and received in a customized particular sequence, as shown in FIG. 6.

Next the interface circuit 500 may receive the signal 625 at the receiver 560. Similarly, in some examples, data conversion and storage may be performed.

Next the interface circuit 500 may generate and transmit a signal 630 selectively addressed to the sensor 555 to cause the sensor to return a signal 635 (e.g., measurement values). The process may repeat until the interface circuit 500 generates and receives needed signals from all the sensors.

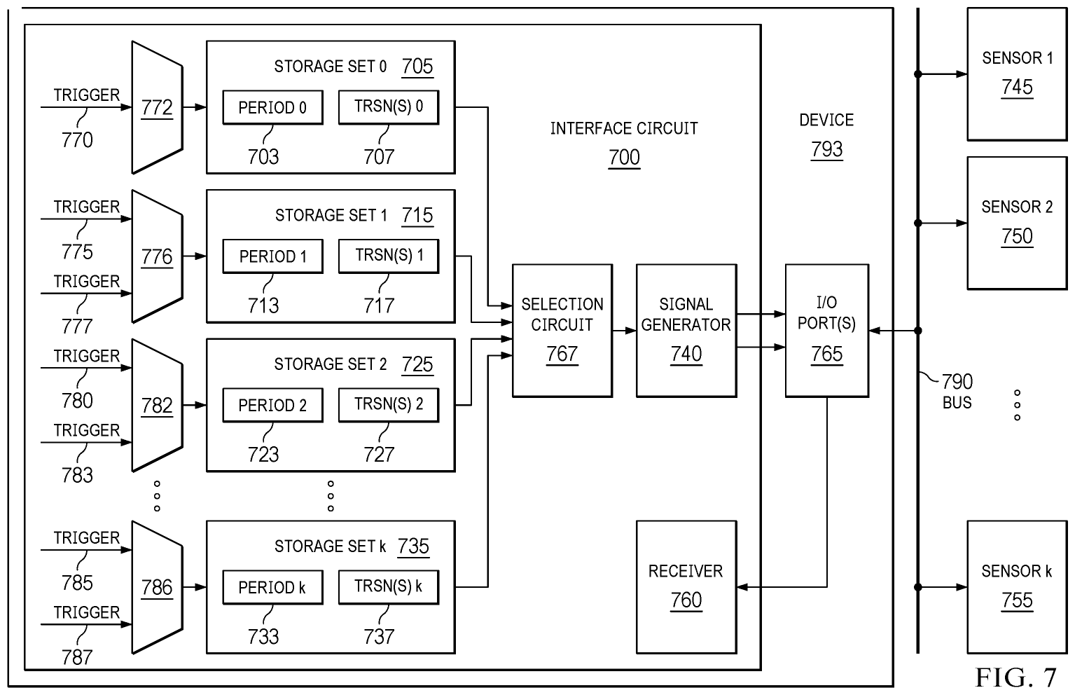

FIG. 7 is a block diagram of an interface circuit operating one or more SENT sensors according to some examples. FIG. 7 shows an interface circuit 700 similar to the interface circuit 500 of FIG. 5. FIG. 7 differs from FIG. 5 in showing a selection circuit 767 as part of the interface circuit 700. In FIG. 7, the interface circuit 700 may be part of a device 793, such as a microcontroller, a DSP, and/or other types of control devices. The interface circuit 700 may include a first set of storage 705, one or more second sets of storage 715, 725, and 735, a signal generator 740, a receiver 760, and the selection circuit 767. The storage sets 705, 715, 725, and 735 may each include one or more registers to store a corresponding set of values for a first parameter and one or more second parameters. As shown in FIG. 7, the storage set 705 may store values of a period parameter 703 and one or more transition parameters 707, the storage set 715 may store values of a period parameter 713 and one or more transition parameters 717, the storage set 725 may store values of a period parameter 723 and one or more transition parameters 727, and the storage set 735 may store values of a period parameter 733 and one or more transition parameters 737.

In some examples, the signal generator 740 may be similar to the signal generator 540 of FIG. 5. The signal generator 740 may generate signals for the storage sets 705, 715, 725, and 735 respectively according to values of the period and transition parameters stored at these storage sets. In some examples, a value of a period parameter may specify a period of a signal, whereas values of the transition parameters may specify transitions of the signal. In addition, values of these period parameter and/or transition parameters may be programmable, such that the signal generator 740 may generate customizable signals having particular periods and/or pulses to operate sensors having different communication requirements. In some examples, the receiver 760 may be similar to the receiver 560 of FIG. 5, and I/O port(s) 765 may be similar to the I/O port(s) 565 of FIG. 5. For example, the I/O port(s) 765 may operate in either output or input direction under control of the signal generator 740. Similarly, upon receiving signals from the SENT sensors, the receiver 760 may perform signal decoding and/or storage.

In some examples, the storage sets 705, 715, 725, and 735 may receive respective triggers. For example, the storage set 705 may receive storage 770, the storage set 715 may receive triggers 775 and 777, the storage set 725 may receive triggers 780 and 783, and the storage set 535 may receive triggers 785 and 787. The triggers 770, 775, 777, 780, 783, 785, and 787 may be similar to the triggers 570, 575, 577, 580, 583, 585, and 587. For example, the triggers 770, 775, 777, 780, 783, 785, and 787 may trigger the storage sets 705, 715, 725, and 735 to request the signal generator 740 to generate signals for the storage sets based on their respective stored values. In addition, at least some of the triggers 770, 775, 777, 780, 783, 785, and 787 may be generated independently, and/or at least some of the triggers may depend on each other. The dependent relationships may ensure the signal generator 740 to generate and receive signals with one or more sensors 745, 750, and 755 in a programmable sequence to meet particular communication protocol requirements. In addition, in some examples, the circuit 700 may include one or more logic circuits, e.g., multiplexers 772, 776, 782, and 786, to perform logic operations on the triggers 770, 775, 777, 780, 783, 785, and 787 to generate the resultant triggers for the respective storage sets 705, 715, 725, and 735.

In some examples, the interface circuit 700 may include a selection circuit 767. As shown in FIG. 7, the selection circuit may be coupled operatively between the storage sets 705-735 and the signal generator 740. In some examples, the selection circuit may function as an “arbiter” to determine which one of the storage sets may request the signal generator 740 to generate a signal. For example, when multiple storage sets send requests at or around the same time to the signal generator 740, the selection circuit 767 may select one of the requests to the signal generator 740 at one time. In some examples, the selection circuit 767 may select the storage sets 705, 715, 725, and 735 according to a fixed sequence. For example, the selection circuit 767 may always choose the storage set 705 ahead of the storage set 715, the storage set 715 ahead of the storage set 725, the storage set 725 ahead of the storage set 735, and so on. In some examples, each of the storage sets 705, 715, 725, and 735 may be associated with a respective priority, and the selection circuit 767 may perform the selection based on the priorities of the storage sets. In some examples, priorities of the storage sets 705, 715, 725, and 735 may be programmable, such that a user may customize priorities between the different storage sets and thus determine the sequence in which requests may be sent to the signal generator 740 for generating signals.

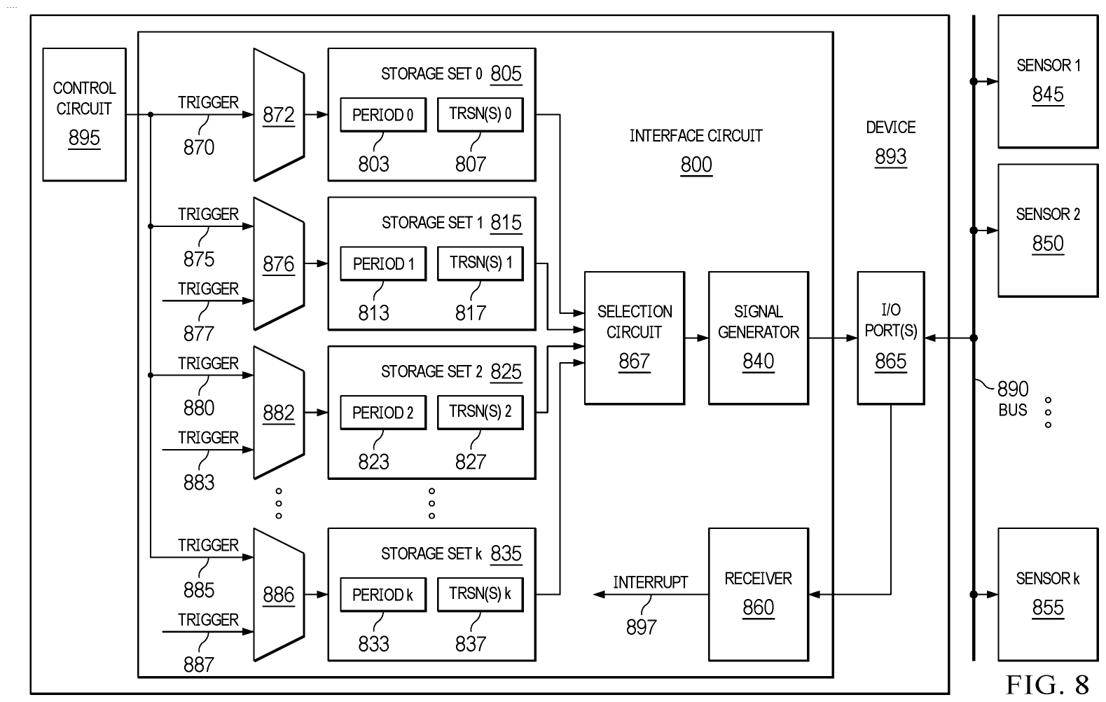

FIG. 8 is a block diagram of an interface circuit operating one or more sensors according to some examples. In FIG. 8, an interface circuit 800 may be part of a device 893. In some examples, the device 893 may include a microcontroller, a DSP, and/or other types of control devices. The device 893 may include the interface circuit 800, a control circuit 895, and I/O port(s) 865.

In some examples, the interface circuit 800 may be similar to the interface circuit 700 of FIG. 7. The interface circuit 800 may include a first set of storage 805, one or more second sets of storage 815, 825, and 835, a signal generator 840, a receiver 860, and a selection circuit 867. The storage sets 805, 815, 825, and 835 may be similar to the storage sets 705, 715, 725, and 735 of FIG. 7. For example, the storage sets 805, 815, 825, and 835 may each include one or more registers to store values for a corresponding set of a first parameter and one or more second parameters. As shown in FIG. 8, the storage set 805 may store values of a period parameter 803 and one or more transition parameters 807, the storage set 815 may store values of a period parameter 813 and one or more transition parameters 817, the storage set 825 may store values of a period parameter 823 and one or more transition parameters 827, and the storage set 835 may store values of a period parameter 833 and one or more transition parameters 837.

In some examples, the signal generator 840 may be similar to the signal generator 740 of FIG. 7. The signal generator 840 may generate signals for the storage sets 805, 815, 825, and 835 respectively according to values of the period and transition parameters stored at these storage sets. In some examples, a value of a period parameter may specify a period of a signal, whereas values of the transition parameters may specify transitions of the signal. In addition, values of these period parameter and/or transition parameters may be programmable, such that the signal generator 840 may generate customizable signals having particular periods and/or pulses to operate sensors having different communication requirements. In some examples, the receiver 860 may be similar to the receiver 760 of FIG. 7, and I/O port(s) 865 may be similar to the I/O port(s) 765 of FIG. 7. For example, the I/O por(t)s 865 may operate in either output or input direction under control of the signal generator 840. Similarly, the receiver 860 may receive signals (e.g., measurement values) from one or more sensors 845, 850, and 855. In some examples, the sensors 845, 850, and 855 may include SENT sensors that may operate according to the traditional and/or specialized SENT protocols. In some examples, the receiver 860 may perform signal decoding and storage. In some examples, when it receives a signal from one of the sensors, the receiver 860 may generate an interrupt 897. The interrupt 897 may cause the device 893 to execute an interrupt service routine (ISR) to perform desired functions based on the received signal. For example, as described above, the receiver 860 may decode signals from the sensors 845-855 to determine the encoded signal values (e.g., measurement values). Accordingly, the ISR may obtain the values and/or perform one or more further control actions (e.g., speed and/or torque control, etc.).

In some examples, the storage sets 805, 815, 825, and 835 may receive respective triggers. For example, the storage set 805 may receive trigger 870, the storage set 815 may receive triggers 875 and 877, the storage set 825 may receive triggers 880 and 883, and the storage set 835 may receive triggers 885 and 887. The triggers 870, 875, 877, 880, 883, 885, and 887 may be similar to the triggers 770, 775, 777, 780, 783, 785, and 787. For example, the triggers 870, 875, 877, 880, 883, 885, and 787 may trigger the storage sets 805, 815, 825, and 835 to request the signal generator 840 to generate signals for the respective storage sets. In some examples, the triggers 870, 875, 880, and 885 may be generated independently at the control circuit 895. For example, the control circuit 895 may include one or more pulse-width-modulation (PWM) modules that may generate the triggers 870, 875, 880, and 885 at configured points in time associated with specified PWM waveforms. In addition, some or all of the storage sets 805, 815, 825, and 835 may each receive more than one triggers, and one of the multiple triggers may be selected at one time (e.g., using the multiplexers 872, 876, 882, and/or 886) to trigger the storage sets.

In some examples, the triggers 877, 883, and 887 may be generated based on status of other signals. For example, the trigger 877 may be generated based on status of a first signal generated (e.g., a broadcast handshaking signal generated by the signal generator 840) for the storage set 805, the trigger 883 may be generated based on status of a response signal from one of the sensors 845, 850, and 855 in response to a second signal generated (e.g., a addressed trigger signal generated by the signal generator 840) for the storage set 815, and so on. As described above, this may ensure the interface circuit 800 to transmit signals for the storage sets and receive corresponding response signals from the sensors 845, 850, and 855 in a particular sequence to meet the sensors' communication requirements.

In some examples, the selection circuit 867 may be similar to the selection circuit 767 of FIG. 7. For example, the selection circuit 867 may determine the order and/or priority for the storage sets 805, 815, 825, and 835 to request the signal generator 840 for generating signals. In some examples, the selection circuit 867 may make selections according to a specified sequence. In some examples, it may select the storage sets based on their respective priorities.

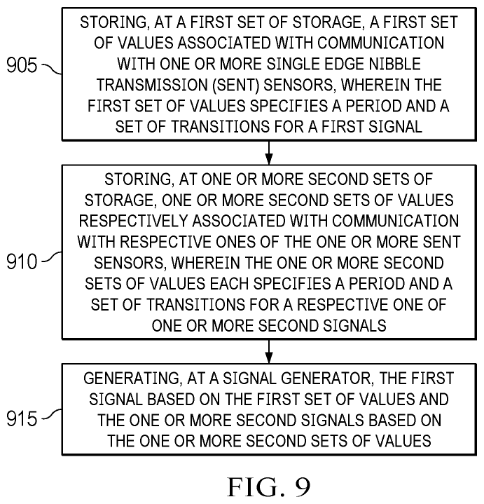

FIG. 9 is a flowchart of a method for using an interface circuit to operate one or more sensors according to some examples. In some examples, an interface circuit (e.g., the interface circuits described above) may store, at a first set of storage (e.g., the first set of storage described above), a first set of values associated with communication with one or more sensors, as indicated by block 905. In some examples, the first set of values specifies a period and a set of transitions for a first signal.

In some examples, the interface circuit may storage, at one or more second sets of storage (e.g., the second sets of storage described above), one or more second sets of values respectively associated with communication with respective ones of the one or more sensors, as indicated by block 910. In some examples, the one or more second sets of values each specifies a period and a set of transitions for a respective one of one or more second signals.

In some examples, the interface circuit may generate, at a signal generator (e.g., the signal generator described above), the first signal based on the first set of values and the one or more second signals based on the one or more second sets of values, as indicated by block 915.

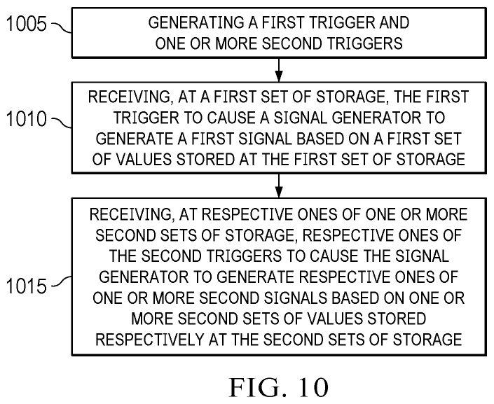

FIG. 10 is a flowchart of a method for using an interface circuit to operate one or more sensors according to some examples. In some examples, a control circuit (e.g., the control circuit described above) may generate a first trigger and one or more second triggers, as indicated by block 1005. As described above, in some examples, at least some of the triggers may be independent from each other, and/or at least some of the triggers may have dependent relationships between each other.

In some examples, an interface circuit (e.g., the interface circuits described above) may receive, at a first set of storage (e.g., the first set of storage described above), the first trigger to cause a signal generator (e.g., the signal generator described above) to generate a first signal based on a first set of values stored at the first set of storage, as indicated by block 1010. As described above, the first set of values may specify a period and a set of transitions of the first signal.

In some examples, the interface circuit may receive, at respective ones of one or more second sets of storage (e.g., the second sets of storage described above), respective ones of the one or more second triggers to cause the signal generator to generate respective ones of one or more second signals based on one or more second sets of values stored at the second sets of storage, as indicated by block 1015. As described above, each of the one or more second sets of values may specify a period and a set of transitions of a corresponding one of the one or more second signals.

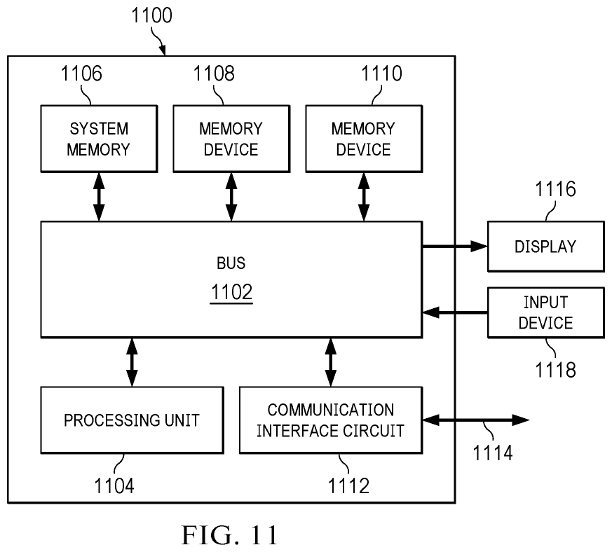

FIG. 11 is a schematic block diagram illustrating an exemplary system of hardware components configurable to implement examples of systems and methods describes above. The system 1100 may include various systems and subsystems. In some examples, the system 1100 may be a microcontroller, a processor, and/or other types of control devices (as described above) having an interface circuit. It shall be appreciated that in some examples, some of the components 1102, 1104, 1106, 1108, 1110, 1112, 1114, 1116, and 1118 may not be necessary.

The system 1100 may include a system bus 1102, a processing unit 1104, a system memory 1106, memory devices 1108 and 1110, a communication interface 1112 (e.g., a programmable interface circuit as described above), a communication link 1114, a display 1116 (e.g., a video screen), and an input device 1118 (e.g., a keyboard and/or a mouse). The system bus 1102 may be in communication with the processing unit 1104 and the system memory 1106. The additional memory devices 1108 and 1110, such as a hard disk drive, server, stand-alone database, or other non-volatile memory, may also be in communication with the system bus 1102. The system bus 1102 may interconnect the processing unit 1104, the memory devices 1106-1110, the communication interface 1112, the display 1116, and the input device 1118. In some examples, the system bus 1102 may also interconnect an additional port (not shown), such as a universal serial bus (USB) port.

The processing unit 1104 may be a computing device and may include a general-purpose central processor (CPU), a digital signal processor (DSP), and/or other processing circuits. The processing unit 1104 may execute a set of instructions to implement the operations of examples disclosed herein. The processing unit may include a processing core.

The additional memory devices 1106, 1108, and 1110 may store data, programs, instructions, database queries in text or compiled form, and any other information that may be needed to operate a computer. The memories 1106, 1108, and 1110 may be implemented as computer-readable media (integrated or removable) such as a memory card, disk drive, compact disk (CD), or server accessible over a network. In certain examples, the memories 1106, 1108 and 1110 may comprise text, images, video, and/or audio, portions of which may be available in formats comprehensible to human beings.

In operation, the system 1100 may be configured to implement one or more parts of a system according to the present disclosure. Computer executable logic for implementing the system may reside on one or more of the system memory 1106, and the memory devices 1108, 1110 in accordance with certain examples. The processing unit 1104 may execute one or more computer executable instructions originating from the system memory 1106 and the memory devices 1108 and 1110. In some examples, the instructions may cause the processing unit 1104 to configure the communication interface circuit 1112 to perform programmable interface functions to operate one or more sensors, including SENT sensors, as described above.

The term “computer readable medium” as used herein refers to any medium that participates in providing instructions to the processing unit 1104 for execution, and it will be appreciated that a computer readable medium can include multiple computer readable media each operatively connected to the processing unit.

The above examples are illustrative of several possible embodiments of various aspects of the present disclosure, wherein equivalent alterations and/or modifications will occur to others skilled in the art upon reading and understanding this specification and the annexed drawings. Modifications are possible in the described embodiments, and other embodiments are possible, within the scope of the claims.

The term “couple” is used throughout the specification. The term may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B. As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

What is claimed is:

1. A circuit, comprising:
a first set of storage configured to store a first set of values associated with communication with one or more Single Edge Nibble Transmission (SENT) sensors, wherein the first set of values specifies a period and a set of transitions for a first signal;
a second set of storage configured to store a second set of values associated with communication with a first SENT sensor of the one or more SENT sensors, wherein the second set of values specifies a period and a set of transitions for a second signal; and
a signal generator coupled to the first set of storage and the second set of storage and configured to generate the first signal based on the first set of values and the second signal based on the second set of values.

2. The circuit of claim 1, wherein:
the first set of storage is configured to receive a first trigger to cause the signal generator to generate the first signal; and
the second set of storage is configured to receive a second trigger to cause the signal generator to generate the second signal.

3. The circuit of claim 2, wherein the second trigger of the second set of storage is associated with the first signal generated for the first set of storage.

4. The circuit of claim 2, further comprising:
another second set of storage configured to store another second set of values associated with communication with a second SENT sensor of the one or more SENT sensors, wherein the second set of values specifies a period and a set of transitions for a third signal,
wherein the signal generator is further coupled to the other second set of storage and further configured to generate the third signal based on the other second set of values.

5. The circuit of claim 4, wherein:
the other second set of storage is configured to receive another second trigger to cause the signal generator to generate the other second signal; and
the other second trigger is associated with a signal from the first SENT sensor corresponding to the second signal generated for the second set of storage.

6. The circuit of claim 2, wherein the first signal comprises a low pulse of a specified width.

7. The circuit of claim 2, wherein the second signal comprises a high pulse having a falling edge with a specific timing.

8. The circuit of claim 7, wherein the second signal causes the first SENT sensor to send a signal to the circuit.

9. The circuit of claim 8, further comprising:
a receiver configured to:
receive the signal from the first SENT sensor; and
decode the received signal.

10. The circuit of claim 1, further comprising:
a selection circuit configured to select one of the first set of storage and the second set of storage for the signal generator to generate one of the first signal and the second signal for the selected set of storage.

11. The circuit of claim 10, wherein:
the first set of storage and the second set of storage each has a respective priority; and
the selection circuit is configured to make the selection based on the respective priorities of the first set of storage and the second set of storage.

12. A system, comprising:
a first circuit configured to generate a first trigger and a second trigger;
a second circuit comprising:
a first set of storage;
a second set of storage; and
a signal generator coupled to the first set of storage and the second set of storage,
wherein the first set of storage is configured to store a first set of values associated with communication with one or more Single Edge Nibble Transmission (SENT) sensors, wherein the first set of values specifies a period and a set of transitions for a first signal,
wherein the second set of storage is configured to store a second set of values associated with communication with a first SENT sensor of the one or more SENT sensors, wherein the second set of values specifies a period and a set of transitions for a second signals, and
wherein the first set of storage and the second set of storage are configured to receive respectively the first trigger and the second trigger to cause the signal generator to generate the first signal based on the first set of values and the second signal based on the second set of values.

13. The system of claim 12, wherein the second trigger of the second set of storage is associated with the first signal generated for the first set of storage.

14. The system of claim 12, wherein:
the first circuit is further configured to generate another second trigger;
the second circuit further comprises another second set of storage configured to store another second set of values associated with communication with a second SENT sensor of the one or more SENT sensors, wherein the other second set of values specifies a period and a set of transitions for another second signal;
the other second set of storage is configured to receive the other second trigger to cause the signal generator to generate the other second signal based on the other second set of values; and
the other second trigger is associated with a signal from the first SENT sensor corresponding to the second signal generated for the second set of storage.

15. The system of claim 12, wherein the first signal comprises one or more pulses each with a specified pulse width.

16. The system of claim 12, wherein the second signal causes the first SENT sensor to send a signal to the second circuit.

17. The system of claim 16, wherein the second circuit further comprises:
a receiver configured to receive the signal from the first SENT sensor, wherein the receiver is decoupled from the one or more SENT sensors when the first and second signals are transmitted to the one or more SENT sensors.

18. The system of claim 12, wherein the second circuit further comprises:
a selection circuit configured to select one of the first set of storage and the second set of storage for the signal generator to generate one of the first signal and the second signal for the selected set of storage.

19. A non-transitory computer readable medium storing program instructions that when executed by a processing unit cause the processing unit to:
store, at a first set of storage, a first set of values associated with communication with one or more Single Edge Nibble Transmission (SENT) sensors, wherein the first set of values specifies a period and a set of transitions for a first signal;
store, at one or more second sets of storage, one or more second sets of values respectively associated with communication with respective ones of the one or more SENT sensors, wherein the one or more second sets of values each specifies a period and a set of transitions for a respective one of one or more second signals; and
generate, at a signal generator, the first signal based on the first set of values and the one or more second signals based on the one or more second sets of values.

20. The non-transitory computer readable medium of claim 19, wherein the program instructions cause the processing unit to generate a first trigger and one or more second triggers, wherein the first trigger is received at the first set of storage to cause the signal generator to generate the first signal, and wherein the one or more second triggers each is received at a respective one of the one or more second sets of storage to cause the signal generator to generate a respective one of the one or more second signals.
